(19) United States
(12) Patent Application Publication
(10) Pub. No.: US 2005/0207336 A1
(43) Pub. Date: Sep. 22, 2005

(54) System and method of receiving various packet services through the same internet protocol address in a universal mobile telecommunication service system

(75) Inventors: Gyu-Il Choi, Seoul (KR); Dong-Wook Suh, Suwon-si (KR)

Correspondence Address: ROYLANCE, ABRAMS, BERDO & GOODMAN, L.L.P., 1300 19TH STREET, N.W., SUITE 600, WASHINGTON,, DC, 20036, US

(73) Assignee: Samsung Electronics Co., Ltd.

(21) Appl. No.: 11/075,747

(22) Filed: Mar. 10, 2005

(30) Foreign Application Priority Data
Mar. 19, 2004 (KR) 2004-18830

(51) Int. Cl. H04J 11/00

(52) U.S. Cl. 370/208

(57) ABSTRACT

A system and method are provided for receiving various packet services using the same Internet protocol address in a wideband code division multiple access universal mobile telecommunication service system. A user equipment receives information corresponding to additional packet services from a short message server through a short message. The user equipment receives the additional packet services as well as a currently used packet service through the same Internet protocol address.

### PRIORITY

This application claims the benefit under 35. U.S.C. 119(a) of an application entitled “Method Of Receiving Various Packet Services Through The Same Internet Protocol Address In Universal Mobile Telecommunication Service System” filed with the Korean Intellectual Property Office on Mar. 19, 2004 and assigned Serial No. 2004-18830, the entire contents of which are incorporated herein by reference.

### BACKGROUND OF THE INVENTION

1. Field of the Invention

The present invention relates to a system and method of receiving various packet services in a communication system. More particularly, the present invention relates to a system and method of receiving various packet services through the same Internet protocol (IP) address in a wideband code division multiple access (WCDMA) universal mobile telecommunication service (UMTS) system.

2. Description of the Related Art

Recently, mobile communication systems have developed into high rate and high quality radio data packet communication systems capable of providing data services and multimedia services in addition to basic voice services. A universal mobile telecommunication service (UMTS) system, which is a 3^{rd} generation mobile communication system employing wideband code division multiple access (WCDMA) based on a European global system for mobile communications (GSM) and general packet radio services (GPRS), provides subscribers using mobile phones or computers with packet-based text, digital voice, video data and multimedia data at a high transmission rate above 2 Mbps regardless of the location of the subscribers.

The UMTS system employs a packet switching type access scheme by using a packet protocol, such as Internet Protocol (IP), so the subscriber can access the UMTS system even if the subscriber is located at an endpoint in a network.

FIG. 1 is a view illustrating a conventional procedure of receiving various types of packet services.

Referring to FIG. 1, a user equipment (UE) 100 accesses a UMTS terrestrial radio access network (UTRAN) 10 in order to process a call and supports a circuit service (CP) and a packet service (PS).

The UTRAN includes a Node B (not shown) and a radio network controller (RNC) (not shown). The Node B is connected to the UE 100 through a Uu interface. That is, the UTRAN conducts protocol conversion in order to transfer radio data or control messages, which have been transmitted from the UE 100, to a core network (CN) using a GPRS tunneling protocol (GTP).

Herein, the CN refers to a serving GRPS support Node (SGSN) (not shown) and a gateway GPRS support Node (GGSN) 110. The SGSN manages subscriber information and position information of the UE 100. The GGSN 110 is an endpoint of the GTP in a UMTS network and cooperates with external networks 121, 122 and 123 through a Gi interface in order to provide services requested by the UE. That is, the GGSN 110 can be connected to the Internet, a packet domain network (PDN), or other PLMNs.

The UE 100 can establish a call based on an access point name (APN) of a service in order to receive packet data. That is, the UE 100 must recognize the APN of the packet service to be used and the UE 100 accesses a server providing the service by operating an APN connection key. In addition, it is also possible to directly input the APN into the UE 100 so as to allow the UE 100 to access the server providing the service for establishing the call.

In general, the APN is used in relation to a packet service or a packet domain network providing the packet services. When the APN is used in relation to the packet service, one packet service is mapped with one APN.

Accordingly, the UE 100 may access a network according to the APN corresponding to services, thereby receiving the IP address and establishing the call.

For instance, when a packet service is required for business, the UE 100 accesses an APN (samsung.com) 111 of the GGSN 110 through a first IP address (10.1.1.1). At this time, the GGSN 110 accesses a samsung.com server 121 corresponding to the APN 111 to receive data from the samsung.com server 121. Then, the GGSN 110 transmits the data to the UE 100 to provide the UE 100 with the service.

In addition, when a video on demand service is required, the UE 100 accesses an APN (vod.samsung.com) 112 of the GGSN 110 through a second IP address (10.1.1.2) and receives video packet data from a vod.Samsung.com server 122 corresponding to the APN 112.

If a game service is required, the UE 100 accesses an APN (game.gameland.com) 113 of the GGSN through a third IP address (10.1.1.3) and receives the game service from a game.gameland.com server 123 corresponding to the APN 113.

As mentioned above, the UE 100 must obtain additional IP addresses by performing a packet data protocol (PDP) context activation procedure corresponding to packet services in order to receive other packet services while receiving the current packet service.

That is, the UE 100 must obtain the first IP address (10.1.1.1) to access the APN 111 for receiving the first service, the second IP address (10.1.1.2) to access the APN 112 for receiving the second service, and the third IP address (10.1.1.3) to access the APN 113 for receiving the third service.

In other words, in the conventional mobile communication system, if the UE requests various packet services, which are different from each other, it is necessary to allocate additional IP addresses corresponding to the packet services for the UE. Accordingly, it is impossible to effectively use IP resources because IP addresses are assigned inefficiently. In addition, if a system manager adds/changes/deletes the packet services, the UE may not receive service quality information on the changed packet services, the IP address and port information of the server, and the APN. In addition, if a plurality of UEs simultaneously request a specific packet service, the conventional mobile communication system does not effectively distribute the specific packet service to the UEs, so the quality of the packet service may be degraded.

Thus, there is a need for a system and method that efficiently assigns IP addresses when additional services are requested. There is an additional need for a system and method for receiving service information for a UE when the service information has been changed.

### SUMMARY OF THE INVENTION

Accordingly, the present invention has been made to solve the above-mentioned problems occurring in the prior art, and an object of the present invention is to provide a system and method of allowing a user equipment (UE) to effectively receive various packet data services through the same Internet Protocol (IP) in a universal mobile telecommunication service system.

Another object of the present invention is to provide a system and method of allowing a UE to receive additional packet services through the same IP while differentiating the additional packet services from a previously requested packet service when the UE requests the additional packet services in a universal mobile telecommunication service system.

Still another object of the present invention is to provide a system and method of allowing a UE to effectively receive service information of the UE when the service information has been changed.

Still another object of the present invention is to provide a system and method of allowing a UE to effectively receive service information of the UE through a short message service when the service information has been changed.

In order to accomplish these objects, according to a first aspect of the present invention, there is provided a system and method of receiving various packet services by using the same internet protocol (IP) address in a universal mobile telecommunication service (UMTS) system. The system and method comprise establishing an access point name (APN) corresponding to a first packet service requested by a user equipment (UE) that maintains an idle state through a core network and transmitting quality of service (QoS) information and identification (ID) information, which is used for differentiating a second packet service from the first packet service, to a service management server; transmitting the APN, QoS information, and ID information to a short message server by means of the service management server; transmitting a short message including the APN, QoS information, and ID information to the UE by means of the service management server; and updating the APN, QoS information, and ID information and receiving packet data according to the first packet service and the second packet service by establishing a call.

In order to accomplish these objects, according to a second aspect of the present invention, there is provided a system and method of receiving a first packet service and a second packet service by receiving the same internet protocol (IP) address in a universal mobile telecommunication service (UMTS) system. The system and method comprise allowing a user equipment (UE) to perform a packet data protocol (PDP) context activation procedure in relation to a core network by using call identification (ID) information corresponding to the first packet service and an access point name (APN) of the first packet service in such a manner that the UE receives an Internet Protocol (IP) address for the first packet service from the core network; allowing the UE to perform the PDP context activation procedure in relation to the core network by using call ID information corresponding to the second packet service, the APN of the second packet service, and the IP address for the first packet service; and allowing the UE to perform a PDP context modification procedure in relation to the core network by using ID information, which is used for differentiating the first packet service from the second packet service.

### BRIEF DESCRIPTION OF THE DRAWINGS

The above and other objects, features and advantages of the present invention will be more apparent from the following detailed description taken in conjunction with the accompanying drawings, in which:

FIG. 1 is a view illustrating a conventional procedure of receiving various types of packet services;

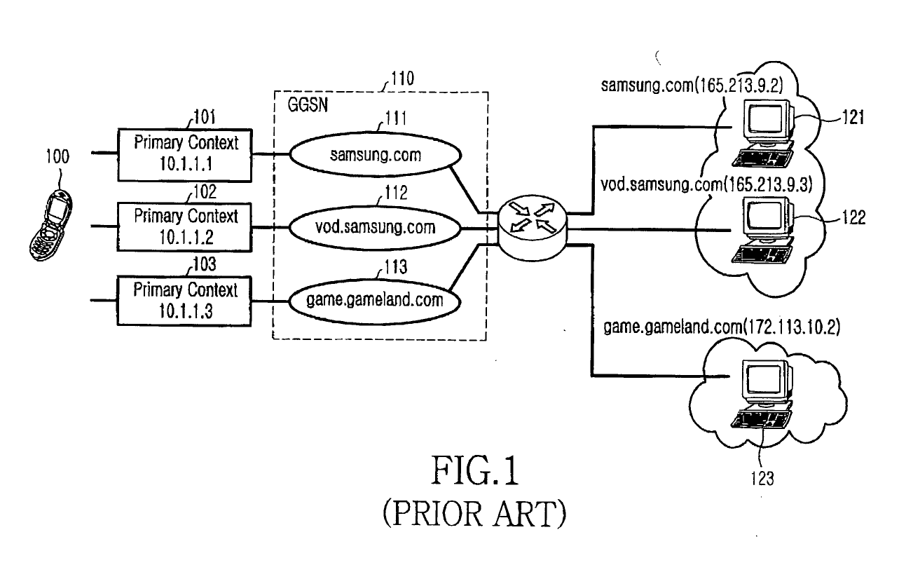

FIG. 2 is a view illustrating a procedure of establishing a call by receiving changed service information through a short message according to an embodiment of the present invention;

FIG. 3 is a view illustrating a procedure of establishing a call through an Internet Protocol (IP) address by receiving changed service information through the same IP address according to an embodiment of the present invention;

FIG. 4 is a flowchart illustrating a procedure of establishing a call through an IP address by allowing a user equipment (UE) to receive changed service information through the same IP address according to an embodiment of the present invention; and

FIG. 5 is a view illustrating signaling between network systems when establishing a call corresponding to various packet services received through the same IP address in a universal mobile telecommunication service system according to an embodiment of the present invention.

Throughout the drawings, the same or similar elements are denoted by the same reference numerals.

### DETAILED DESCRIPTION OF AN EXEMPLARY EMBODIMENTS

Hereinafter, embodiments of the present invention will be described with reference to the accompanying drawings. In the following description of the present invention, a detailed description of known functions and configurations incorporated herein will be omitted for conciseness. In addition, it should be noted that definition of terms used in the following description must be determined based on the whole context of the description.

The embodiments of the present invention provide a method of receiving various packet services, which are different from each other, by using the same Internet Protocol (IP) address in a wideband code division multiple access (WCDMA) universal mobile telecommunication service (UMTS) system. According to an embodiment of the present invention, a user equipment (UE) effectively receives additional service information through a short message transmitted from a short message service server. The UE employs a traffic flow template (TFT) in order to receive additional services as well as a previous service through the same IP.

According to an embodiment of the present invention, the WCDMA UMTS system includes a UE, a gateway GPRS support Node (GGSN), a short message service (SMS) server, a service management server, and a service server. Herein, the service management server may be the same as the service server or may refer to a server capable of managing a plurality of service servers.

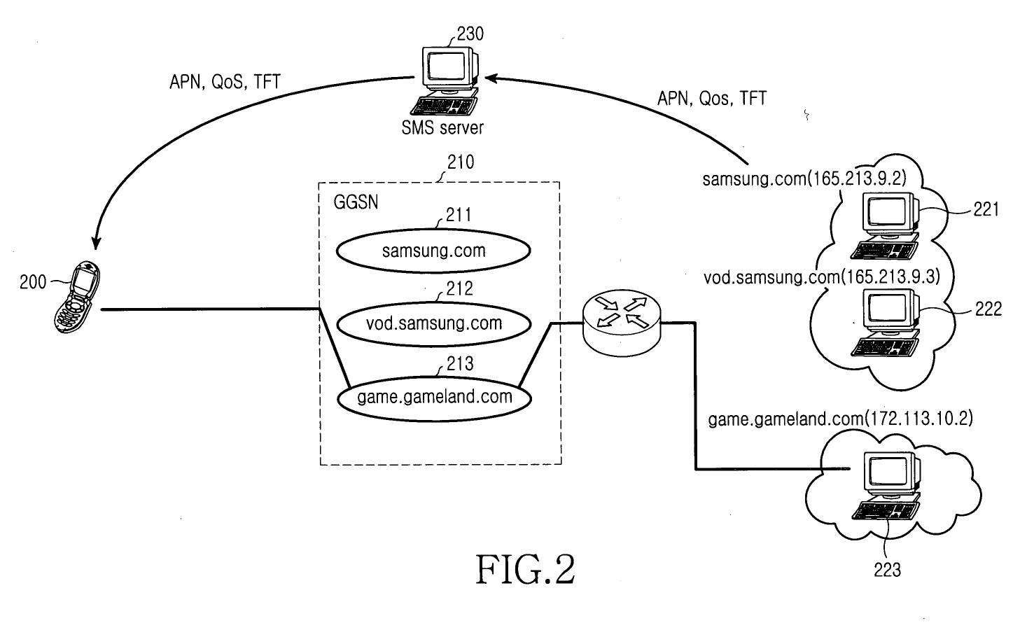

FIG. 2 is a view illustrating a procedure of establishing a call by receiving changed service information through a short message according to an embodiment of the present invention.

Referring to FIG. 2, the UE 200 maintains an idle state in which a call corresponding to a packet service has not been established. In this state, if it is necessary to receive the packet service having a predetermined category, the UE 200 accesses a web page of a communication company, calls an agent or a customer center, or performs a packet data protocol (PDP) context activation procedure to register the predetermined category in the service management server 221. For instance, the UE 200 may request a game service without accessing a specific access point name (APN).

If the service having the predetermined category is provided to the UE 200, the system manager establishes an APN 213 corresponding to the service in the GGSN 210 and sets the APN 213, quality of service (QoS) information, and traffic flow template (TFT) information used for differentiating a new packet service from a previous packet service in the service management server 221. Then, the service management server 221 transmits the APN 213, quality of service (QoS) information, and TFT information to the SMS server 230. Use of the TFT indicates that packet filtering is performed for differentiating packet services from each other and the IP address and port information are obtained for receiving the packet services.

Upon receiving the APN, QoS information, and TFT information from the service management server 221, the SMS server 230 transmits the APN, QoS information, and TFT information to the UE 200 by using the SMS message. At this time, the service management server 221 transmits the APN, QoS information and TFT information through the SMS server 230 by using the SMS message to the UE 200 periodically or whenever the service having the same category is added/changed/deleted. Upon receiving the SMS message from the service management server 221, the UE 200 updates packet service information.

Therefore, when the UE 200 is shifted into an activation state and places a call in order to use the predetermined packet service, the UE 200 conducts the PDP context activation procedure by using the packet service information, that is, the APN and QoS information, thereby establishing the call. After establishing the call according to the packet service, the UE 200 obtains the IP address and port information used for accessing the packet service by using the TFT information and accesses the corresponding service server to use the packet service.

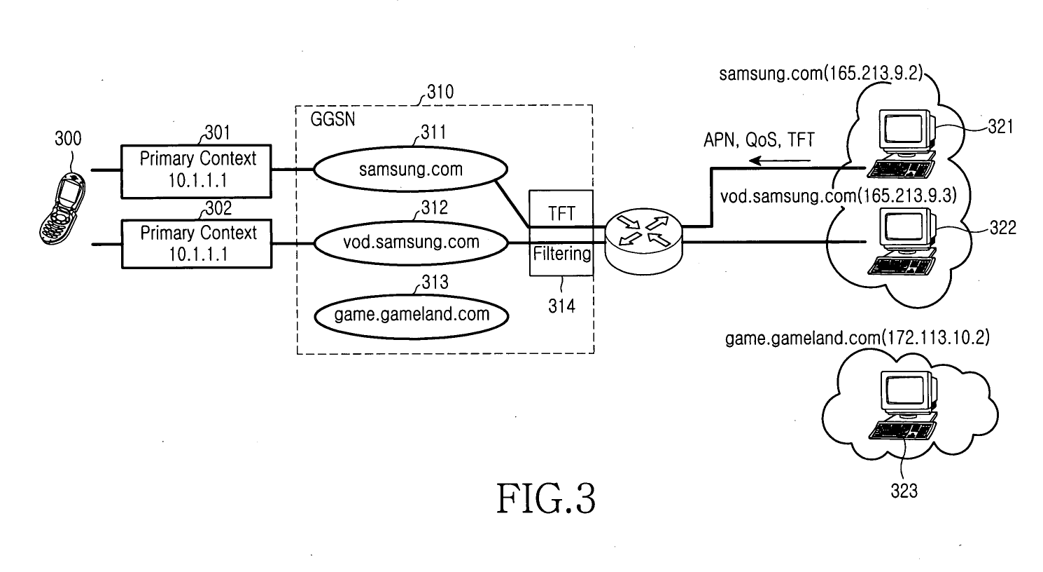

FIG. 3 is a view illustrating a procedure of establishing the call through an IP address by receiving service information through the same IP address according to an embodiment of the present invention.

Referring to FIG. 3, it may happen that the UE 300 cannot receive the packet service information by using the APN, QoS information and TFT information transmitted thereto from the SMS server 230 shown in FIG. 2. At this time, the UE 300 establishes the call for an access point name APN 311 in order to access the service management server 321. Then, the UE 300 accessing the service management server 321 selects a required service. Accordingly, the service management server 321 transmits an APN 312, QoS information, and TFT information corresponding to the service selected by the UE 300 to the UE 300.

At this time, the UE 300 performs the PDP context activation procedure by using the APN 312 and QoS information, thereby establishing the call. Then the UE 300 transmits the TFT information, which has been received in the UE 300 through a mobile subscriber (MS)-initiated PDP context modification procedure, to a GGSN 310. The UE 300 then uses the service by accessing the corresponding service server based on information extracted from the TFT information. The UE 300 must transmit the TFT information to the GGSN 310 because the data streams corresponding to the services from the service servers 321, 322 and 323 are differentiated from each other based on the TFT information in the GGSN 310.

That is, the GGSN 310 differentiates at least two PDP contexts, which are transmitted to the same IP address, through the TFT information transmitted thereto from the UE 300. A TFT filter section 314 of the GGSN 310 receives the TFT information from the UE 300 in order to differentiate the PDP contexts of services transmitted from the service servers 321, 322 and 323.

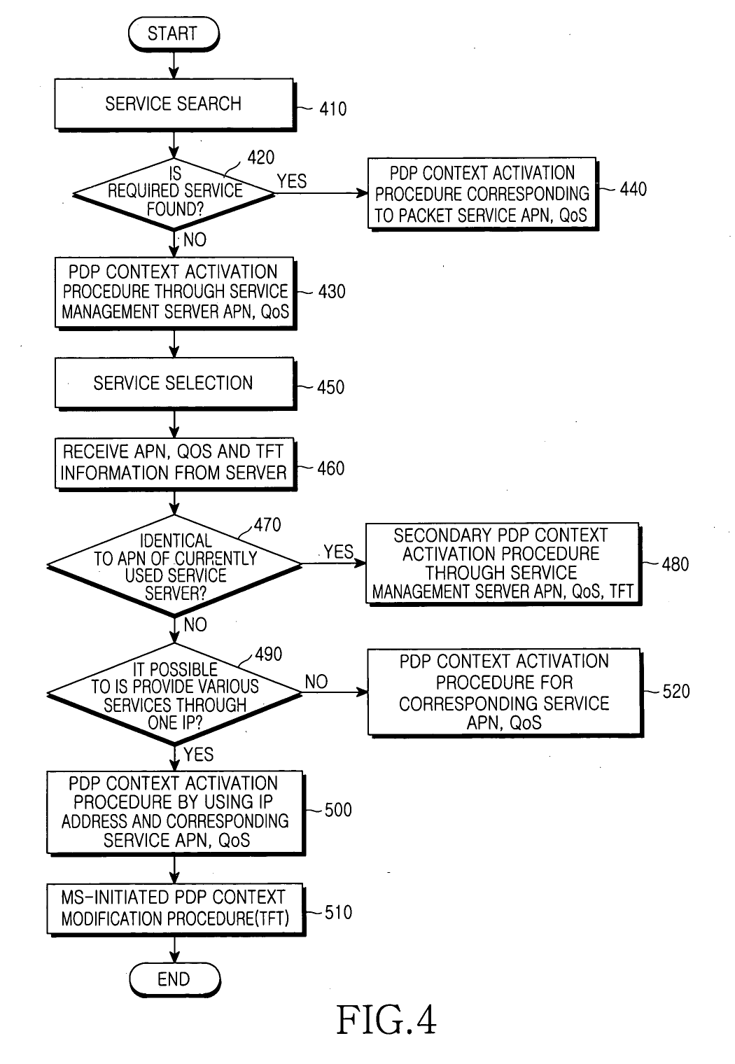

FIG. 4 is a flowchart illustrating a procedure of establishing the call through an IP address by allowing the UE to receive changed service information through the same IP address according to an embodiment of the present invention.

Referring to FIG. 4, the UE searches services so as to check whether there is a service required by the UE in step 410. If it is determined in step 420 that there is a service required by the UE, step 440 is performed. In step 440, the APN and QoS information of the required service are transmitted to perform the PDP context activation procedure corresponding to the packet service. However, if it is determined in step 420 that there is no service required by the UE, step 430 is performed, in which the PDP context activation procedure is performed through the service management server providing the packet data service.

In step 450, the UE accesses the service management server so as to select the required service. Then the UE receives the APN, QoS information and TFT information corresponding to the selected service from the service management server in step 460.

Then, the UE checks whether an APN of a new packet service is identical to the APN of the currently used service server in step 470. If it is determined in step 470 that the APN of the new packet service is identical to the APN of the currently used service server, step 480 is performed.

In step 480, the UE establishes the call through a secondary PDP context activation procedure and uses the same IP address.

However, if it is determined in step 470 that the APN of the new packet service is different from the APN of the currently used service server, step 490 is performed. In step 490, it is determined whether the UE can provide various packet services through one IP address. If it is determined in step 490 that the UE can provide various packet services through one IP address, step 500 is performed. In step 500, the PDP context activation procedure is performed by using the APN, QoS information and the IP address obtained in step 430. Then, TFT information is transmitted so as to differentiate the previous packet service from the new packet service, in which the previous packet service and the new packet service are transmitted through the same IP address in step 510. That is, in step 510, the UE requests modification of the PDP context including the TFT information obtained in step 460, which has been previously created through the PDP context modification procedure.

In contrast, if it is determined in step 490 that the UE cannot provide various packet services through one IP address, the UE transmits the APN and QoS information of the corresponding service to perform the PDP context activation procedure and receives a new IP address based on the PDP context activation procedure in step 520.

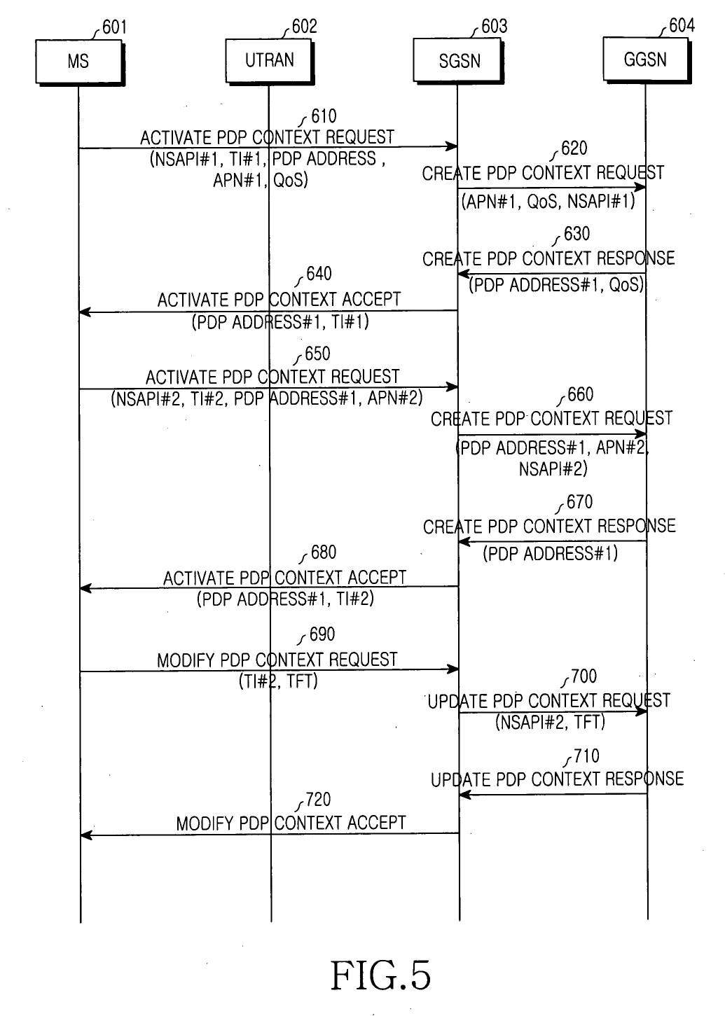

FIG. 5 is a view illustrating signaling between network systems when establishing the call corresponding to various packet services received through the same IP address in a universal mobile telecommunication service system according to an embodiment of the present invention.

Referring to FIG. 5, a UE mobile subscriber (MS) 601 creates a GPRS tunneling protocol (GTP) tunnel in order to establish the call in relation to a first service. To this end, the UE 601 transmits a PDP context activation request message to an SGSN 603 in step 610. Parameters contained in the PDP context activation request message include a network layer service access point identifier (NSAPI), a transaction identifier (TI), a PDP type, a PDP address, an access point network, and QoS information.

Herein, the NSAPI is created from the UE 601 and matches with the PDP context identifier (PDP context ID) one to one. The PDP address is information representing the IP address of the UE 601 used in a UMTS packet domain and forming the PDP context information. The PDP context includes information of the GTP tunnel and is managed based on a PDP context ID. In addition, the TI is used for the UE 601, a UTRAN 602, and the SGSN 603 and allocated to each of the GTP channels with a dedicated value so as to differentiate the GTP channels from each other. That is, although the concept of the TI is similar to the concept of the NSAPI, the TI is used for the UE 601, the UTRAN 602, and the SGSN 603, and the NSAPI is used for the UE 601, the SGSN 603 and a GGSN 604. In addition, the PDP type represents the type of GTP tunnels to be created through the PDP context activation request message. Herein, the type of GTP tunnels includes the IP, a point to point protocol (PPP), and a mobile IP.

In addition, the APN represents an access point of a service network, to which the UE 601 requesting creation of the GTP tunnel is connected. In addition, the QoS represents quality of packet data transmitted through the GTP tunnel, which has been currently created. That is, the packet data using the GTP tunnel having superior QoS is processed prior to the packet data using the GTP tunnel having inferior QoS.

Upon receiving the PDP context activation request message, the SGSN 603 establishes a radio access bearer with respect to the UTRAN 602 and transmits the PDP context creation request message including NSAPI#1, APN#1, and QoS to the GGSN 604 in step 620. At this time, a tunnel endpoint ID (TEID) is formed between the SGSN 603 and the GGSN 604 in order to transmit packet data between network nodes using the GTP tunnel. That is, the SGSN 603 memorizes the TEID of the GGSN 604 and the GGSN 604 memorizes the TEID of the SGSN 603. Thus, the PDP context creation request message includes the TEID, which is used when transmitting the packet data from the GGSN 604 to the SGSN 603.

Upon receiving the PDP context creation request message, the GGSN 604 transmits a response message to the SGSN 603 if the PDP context has been normally created in response to the PDP context creation request message in step 630. At this time, the response message may include a PDP IP address#1 for transmitting the packet service corresponding to the first service and QoS of the first service. In this manner, the GTP tunnel can be created between the SGSN 603 and the GGSN 604 so that it is possible to transmit the packet data. The SGSN 603 receiving the PDP context creation request message transmits a PDP context activation accept message including a PDP IP address#1 and QoS to the UE 601 in step 640.

The UE 601 creates a GTP tunnel in order to establish the call in relation to a second service. To this end, the UE 601 transmits a PDP context activation request message to the SGSN 603 in step 650. The PDP context activation request message includes a NSAPI#2, a TI#2, an APN#2, and QoS information according to the second service and a PDP IP address#1 for the first service.

Upon receiving the PDP context activation request message in relation to the second service, the SGSN 603 establishes a radio access bearer with respect to the UTRAN 602 and transmits the PDP context creation request message including the NSAPI#2, APN#2, QoS and PDP IP address#1 to the GGSN 604 in step 660. The GGSN 604 receiving the PDP context creation request message in relation to the second service transmits a response message including the QoS and PDP IP address#1 to the SGSN 603 if the PDP context has been normally created in response to the PDP context creation request message regarding the second service in step 670. Upon receiving the response message, the SGSN 603 transmits a PDP context activation accept message including a PDP IP address#2 and QoS to the UE 601 in step 680.

After that, the UE 300 transmits a PDP context modification request message including TI#2, QoS#2, and TFT information to the SGSN 603 in order to differentiate the PDPs transmitted through the same PDP IP address#1 in step 690. Upon receiving the PDP context modification request message, the SGSN 603 transmits a PDP context update request message including NSAPI#2, TFT and QoS#2 and corresponding to the UE 601 to the GGSN 604 through the radio access bearer in step 700. Then, the GGSN 604 receiving the PDP context update request message differentiates the second service transmitted through the PDP IP address#1 and transmits a response message including QoS#2 to the SGSN 603 in step 710. Upon receiving the response message from the GGSN 604, the SGSN 603 transmits a PDP context modification accept message including the QoS#2 to the UE 601 in step 720.

Herein, the UE 601 must transmit the TFT information to the GGSN 603 because the data streams corresponding to the services of the UE 601 are differentiated from each other based on the TFT information in the GGSN 603. That is, the GGSN 603 differentiates at least two PDP contexts transmitted through the same IP address by using the TFT information, thereby providing the services to the UE 601.

As described above, according to embodiments of the present invention, various packet data, which are different from each other, can be transmitted through the same IP address, so that radio resource can be saved in the UMTS system. In addition, since the service information is transmitted to the UE by using the short message in real time, service efficiency can be improved. Furthermore, the present invention can efficiently distribute a service load even if a plurality of UEs simultaneously request a specific service, so the QoS can be improved.

While the invention has been shown and described with reference to certain embodiments thereof, it should be understood by those skilled in the art that various changes in form and details may be made therein without departing from the spirit and scope of the invention as defined by the appended claims.

1. A method of receiving various packet services by using the same Internet protocol (IP) address in a universal mobile telecommunication service (UMTS) system, the method comprising the steps of:
establishing an access point name (APN) corresponding to a first packet service requested by a user equipment (UE) that maintains an idle state through a core network and transmitting quality of service (QoS) information and identification (ID) information, which is used for differentiating a second packet service from the first packet service, to a service management server;
transmitting the APN, QoS information, and ID information to a short message server by means of the service management server;
transmitting a short message including the APN, QoS information, and ID information to the UE by means of the service management server; and
updating the APN, QoS information, and ID information and receiving packet data according to the first packet service and the second packet service by establishing a call.

2. The method as claimed in claim 1, wherein the step of receiving the packet data comprises:
shifting the UE from an idle state to an activation state such that the UE performs a packet data protocol (PDP) context activation procedure in relation to the core network based on the received APN and QoS, thereby establishing the call corresponding to the first packet service, and accessing a service server by using the ID information, thereby establishing the call corresponding to the second packet service.

3. The method as claimed in claim 2, wherein the call corresponding to the second packet service is established by allowing the UE to perform the PDP context activation procedure in relation to the core network through an IP address by using the ID information.

4. The method as claimed in claim 2, wherein the call is established by using a first PDP context activation request message.

5. The method as claimed in claim 3, wherein the call corresponding to the second packet message is established by using a first PDP context activation request message.

6. A method of receiving first and second packet services by using the same Internet protocol (IP) address in a universal mobile telecommunication service (UMTS) system, the method comprising the steps of:
allowing a user equipment (UE) to perform a packet data protocol (PDP) context activation procedure in relation to a core network by using call identification (ID) information corresponding to a first packet service and an access point network name (APN) of the first packet service in such a manner that the UE receives an IP address for the first packet service from the core network;
allowing the UE to perform the PDP context activation procedure in relation to the core network by using call ID information corresponding to a second packet service, the APN of the second packet service, and the IP address for the first packet service; and
allowing the UE to perform a PDP context modification procedure in relation to the core network by using ID information, which is used for differentiating the first packet service from the second packet service.

7. The method as claimed in claim 6, wherein the step of receiving the IP address further comprises:
transmitting a PDP context activation request message including call ID information corresponding to the first packet service and the APN of the first packet service to the core network by means of the UE, and establishing the call by receiving a message including the IP address for the first packet service from the core network in response to the PDP context activation request message.

8. The method as claimed in claim 6, wherein the step of performing the PDP context activation procedure comprises:
transmitting a PDP context activation request message including call ID information corresponding to the second packet service and the APN of the second packet service to the core network by means of the UE, and establishing the call by receiving a message including the IP address for the second packet service from the core network in response to the PDP context activation request message.

9. The method as claimed in claim 6, wherein the step of performing the PDP context modification procedure comprises:
transmitting a PDP context modification request message including ID information, which is used for differentiating the first packet service from the second packet service transmitted through the same IP address, to the core network by means of the UE, and establishing calls for the first and second packet services through the same IP address by receiving a message from the core network in response to the PDP context modification request message.

10. A system for receiving various packet services by using the same Internet protocol (IP) address in a universal mobile telecommunication service (UMTS) system, comprising:
a user equipment (UE) for requesting a service and maintaining an idle state until a call is established;
a system manager for establishing an access point name (APN) corresponding to a first packet service requested by the UE via a core network and transmitting quality of service (QoS) information and identification (ID) information, which is used for differentiating a second packet service from the first packet service; and
a short message server for receiving the APN, QoS information, and ID information from the service management server and transmitting a short message including the APN, QoS information, and ID information to the UE from the service management server, wherein the UE updates the APN, QoS information, and ID information and receives packet data according to the first packet service and the second packet service by establishing the call.

11. The system as claimed in claim 10, wherein the UE is shifted from an idle state to an activation state such that the UE performs a packet data protocol (PDP) context activation procedure in relation to the core network based on the received APN and QoS, thereby establishing the call corresponding to the first packet service, and accessing a service server by using the ID information, thereby establishing the call corresponding to the second packet service.

12. The system as claimed in claim 11, wherein the call corresponding to the second packet service is established by allowing the UE to perform the PDP context activation procedure in relation to the core network through an IP address by using the ID information.

13. The system as claimed in claim 11, wherein the call is established by using a first PDP context activation request message.

14. The system as claimed in claim 12, wherein the call corresponding to the second packet message is established by using a first PDP context activation request message.
